(19) United States
(12) Patent Application Publication
(10) Pub. No.: US 2026/0259531 A1
(43) Pub. Date: Sep. 3, 2026

(54) Manufacturing System and Method for Producing Components

(71) Applicant: Bayerische Motoren Werke Aktiengesellschaft, Muenchen (DE)

(72) Inventors: Dominik EXNER, Otterfing (DE); Thiemo FIEGER, Olching (DE); Alexander GRIMM, Karlsfeld (DE); Felix HAECKEL, Muenchen (DE); Nicolai SKRYNECKI, Grosskarolinenfeld (DE)

(21) Appl. No.: 18/871,553

(22) PCT Filed: Oct. 9, 2023
(86) PCT No.: PCT/EP2023/077837

§ 371 Date: Dec. 4, 2024

(30) Foreign Application Priority Data
Oct. 18, 2022 (DE) 10 2022 127 209.5

(51) Int. Cl. G05B 13/02; B33Y 50/02; B33Y 80/00

(52) U.S. Cl. CPC G05B 13/0265; B33Y 50/02; B33Y 80/00

(57) ABSTRACT

A manufacturing system and method for producing vehicle components. The system includes production devices for performing additive manufacturing processes for producing the components using process target data, at least one data acquisition device for acquiring field data which characterizes the produced components and/or the manufacturing processes performed, at least one data processing device for evaluating the field data and generating optimized development data and/or for generating optimized process target data using the field data, wherein the manufacturing system is designed to be self-regulating, and whereby the optimized process target data are used by the production devices for producing further components.

### BACKGROUND AND SUMMARY

This disclosure relates to a manufacturing system and a method for producing components, in particular vehicle components.

Traditional vehicle development often involves long development and validation cycles. Vehicle bodies involving small parts and multiple materials lead to a high degree of complexity in the joining processes and require complex production planning. As a result, existing automotive production has little flexibility in terms of modifications.

Against this background, it is an object of the disclosure to specify a way of improving the production of components. In particular, a way that allows for a high degree of modification flexibility. A further aspect of the disclosure is to provide a way of accelerating the development and manufacture of automotive components.

A manufacturing system is specified for the production of components comprising production devices which are configured for performing additive manufacturing processes. In additive manufacturing processes, components are manufactured using process target data. The manufacturing system comprises at least one data acquisition device which is configured for acquiring field data, which characterizes the produced components and/or the performed manufacturing processes. The data acquisition device can include, for example, cameras, sensors, and/or testing devices with which the field data are acquired. The data acquisition device may further comprise a data memory in which the field data are stored.

Furthermore, the manufacturing system has at least one data processing device which is configured for evaluating the field data and generating optimized development data and/or for generating optimized process target data using the field data. The data processing device may include, for example, a computing unit (e.g., a processor) or be a computer on which suitable software for evaluating and generating the desired data runs.

According to the disclosure, the manufacturing system is designed to be self-regulating, whereby the optimized process target data are used by the production devices for producing further components. For example, the optimized process target data are passed on to the production devices as new process target data and serve as the basis for further additive manufacturing processes. The production devices comprising the data acquisition device and the data processing device are preferably in a (wired or wireless) data connection so that data exchange can take place.

The disclosure relates back to the concept of abolishing the previously practiced process and data-processing related separation/decoupling of development and production and instead linking them together in a self-regulating manner. In this context, the term self-regulating refers in particular to the function of a control loop. The field data are fed back to the control loop and influence the construction data or the resulting process target data. This creates a self-optimizing system that already evaluates the components during production, redirects findings back into the development process and uses them to improve the components or production processes. With such a system, it is possible to dispense with pre-series production. Prototype construction can take place directly in the environment of the subsequent series operation and transition virtually seamlessly into series operation. This creates potential for enormous time savings and cost reduction.

In a preferred embodiment, the manufacturing system further comprises a digital data platform, on which at least the optimized development data, the optimized process target data and the field data are stored. Centralized access is made possible by bundling all relevant data on a common data platform. This allows for a high degree of data transparency with fast availability of all relevant parameters and data and can help to further accelerate the development and production process.

In one embodiment, it is particularly preferred that the data platform is designed to be cloud-based. This makes it possible to access the relevant data from different development and/or production sites worldwide. This enables improved collaboration, even over long distances. In particular, the cloud-based data platform can serve as a global blueprint for future production hubs.

The development data comprises data used to develop the components or generated as part of the development process. In particular, construction data (e.g. CAD data), data from product and material databases, quality data, design-specific data, installation space data and/or requirement data are stored as development data. Optimized development data are development data that have been revised based on the field data and, if necessary, modified. Such optimization can be performed, for example, using databases in which a large amount of development data are stored.

Process target data are generated based on the development data. Process target data specify parameters that are necessary in terms of process technology for operating the production devices to produce components. These can include, purely by way of example, material application rates, application speeds or process temperatures. Optimized process target data are process target data that have been revised and, if necessary, modified based on the field data. Optimization can be performed, for example, by selecting process target data from a database with a large amount of process data.

The field data comprise data obtained from components that have already been produced and which qualitatively and/or quantitatively describe the components. This can be quality data, for example, which make it possible to assess the quality of the produced components. In addition, the field data can comprise manufacturing process data that qualitatively and or quantitatively describe the manufacturing processes and/or post-processing processes performed.

For fast and continuous product optimization, it is particularly advantageous if self-learning artificial intelligence is used in a configuration for generating the optimized development data and/or the optimized process data. Self-learning artificial intelligence can include, for example, an artificial neural network that analyzes the field data and generates optimized process data or optimized development data. For example, the artificial neural network can comprise a computing unit (e.g., a processor) and a memory that mimic a neural model.

For the production of large components and/or large component assemblies, it is particularly advantageous if several production devices are arranged in a common manufacturing cell. Within a manufacturing cell, the production devices preferably produce a component or a component assembly together. In such a manufacturing cell, the production devices can cooperate and work with each other and, for example, be networked with each other in terms of data technology and/or control technology.

Additive manufacturing processes performed by the production equipment can in principle be any known additive manufacturing method. These include, for example, laser sintering, laser beam melting or 3D printing. Using these methods, components can be built up in a generative manner. Additive manufacturing processes offer a high degree of flexibility in terms of component geometries. However, it is particularly preferred if the production devices are configured to perform a wire-based additive manufacturing process. The additive manufacturing processes can accordingly include a wire-based additive manufacturing process. In this case, a wire-shaped material is melted using an electric arc or a high-energy source (e.g. laser) and deposited (e.g., via a nozzle) layer by layer in the desired shape by way of a multi-axis manipulator (e.g., multi-axis robot) for producing the component. Examples include WAAM (wire arc additive manufacturing) devices or laser DED (laser direct energy deposition) devices. Wire-based additive manufacturing processes are characterized by very high application speeds and a high degree of flexibility in terms of the applicable geometries. In addition, this process can be used to build components with very high ductility when using a corresponding wire material.

Furthermore, a method for producing components, in particular vehicle components, is specified in which the components are produced by way of production devices in a manufacturing system using process target data in additive manufacturing processes. In the method, field data are acquired which characterize the manufactured components and/or the manufacturing processes performed. The field data are evaluated by at least one data processing device (e.g., a processor) and optimized process target data and, optionally, optimized development data are generated using the field data. The optimized process target data are then used to produce further components by way of the production devices. By generating optimized process target data and feeding this back into the method, the entire production process is designed as a self-regulating and self-optimizing method. The method is preferably carried out with a manufacturing system as described above, and thereby achieves the same technical effects and advantages as have already been described for the manufacturing system. Features and details described in connection with the manufacturing system are also valid in connection with the method according to the disclosure, and vice versa, so that with regard to the disclosure, reference is or can always be made reciprocally to the individual aspects of the disclosure.

In order to enable and implement component changes as quickly as possible, optimized development data and/or optimized process target data are generated in a configuration preferably within a production cycle. This makes it possible to initiate component changes at short notice and to implement them almost overnight.

The manufacturing system can be used to produce a wide range of components. Due to the flexible manufacturing of even highly complex components and the short modification times, the method is particularly suitable for the production of vehicle components, wherein in particular structural components of a vehicle body or chassis components are produced.

Other benefits, features, and details of the disclosure emerge from the following description, in which exemplary embodiments of the disclosure are described in detail by reference to the drawings. The features identified in the claims and in the description can be essential to the disclosure, either individually or in any desired combination. If the term “can” is used in this application, it refers both to a technical possibility and the actual technical implementation.

### BRIEF DESCRIPTION OF THE DRAWINGS

In the following, exemplary embodiments are explained using the accompanying drawings.

FIG. 1 shows a flow diagram illustrating an exemplary manufacturing system and method; and,

FIG. 2 shows a further diagram illustrating an exemplary manufacturing system.

### DETAILED DESCRIPTION OF THE DRAWINGS

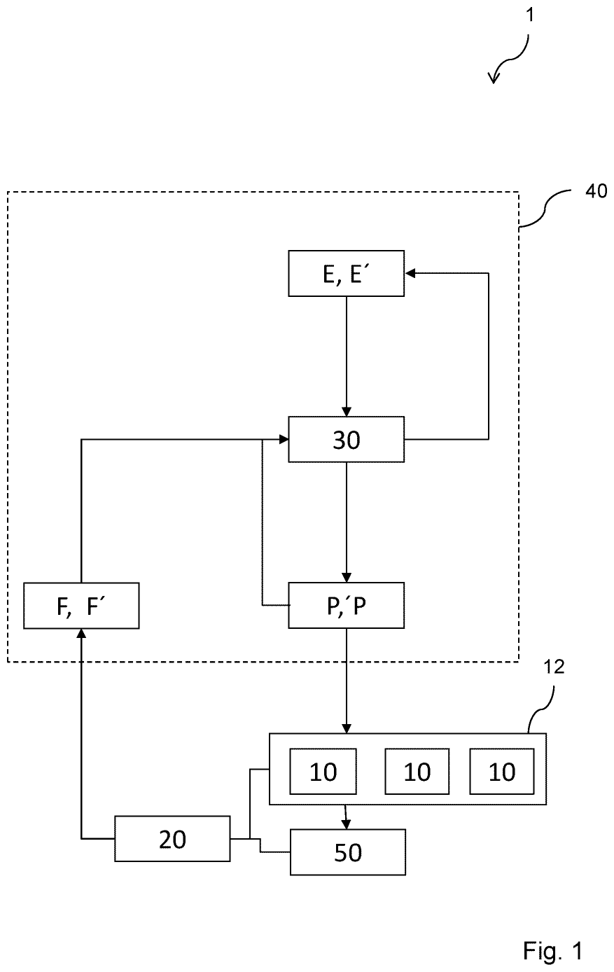

FIG. 1 shows a flow diagram illustrating the processes in an exemplary manufacturing system and in an exemplary method. Based on development data E, process target data P are generated by at least one data processing device 30 (e.g., a computing unit, a processor, or a computer). Based on this process target data P, components, such as vehicle components, are produced in a manufacturing system 1 in additive manufacturing processes by way of production devices 10, as described above. By way of example, according to FIG. 1, three production devices 10 are arranged in a common manufacturing cell 12. The manufacturing system 1 may have more than one manufacturing cell with varying numbers of production devices 10. In some embodiments, a manufacturing cell may be a common facility or location in which the production devices are located.

The manufacturing system 1 further comprises at least one data acquisition device 20 (e.g., cameras, sensors, and/or testing devices), which is configured to acquire field data F, which characterize the manufactured components and/or the manufacturing processes performed. The field data are preferably quality data of the produced components and manufacturing process data of the manufacturing processes performed. Alternatively or in addition, the field data can also be data acquired as part of post-processing processes 50.

The field data F are fed back to the data processing device 30 and evaluated and optimized process target data P′ and, if necessary, optimized development data E′ are generated using the field data F. If optimized development data E′ are generated, these are also included in the optimization of the process target data. The optimization of the development data or process target data is preferably performed by way of self-learning artificial intelligence, which runs, for example, on the data processing device 30.

Based on the existing optimized process target data P′, additional (vehicle) components are generated by way of the production devices 10. In turn, field data F′ are acquired by way of the data acquisition device 20, which are fed back to the data processing device 30 and used for the creation of further optimized process target data P′ and, if necessary, further optimized development data E′. The manufacturing system 1 is therefore self-regulating and thus optimizes component production itself.

The manufacturing system 1 additionally has a data platform 40 on which at least the optimized development data E′, the optimized process target data P′ and the field data F are stored. Furthermore, the original development data E and the original process target data P can be stored on the data platform 40. The data platform 40 is preferably designed as a cloud-based data platform.

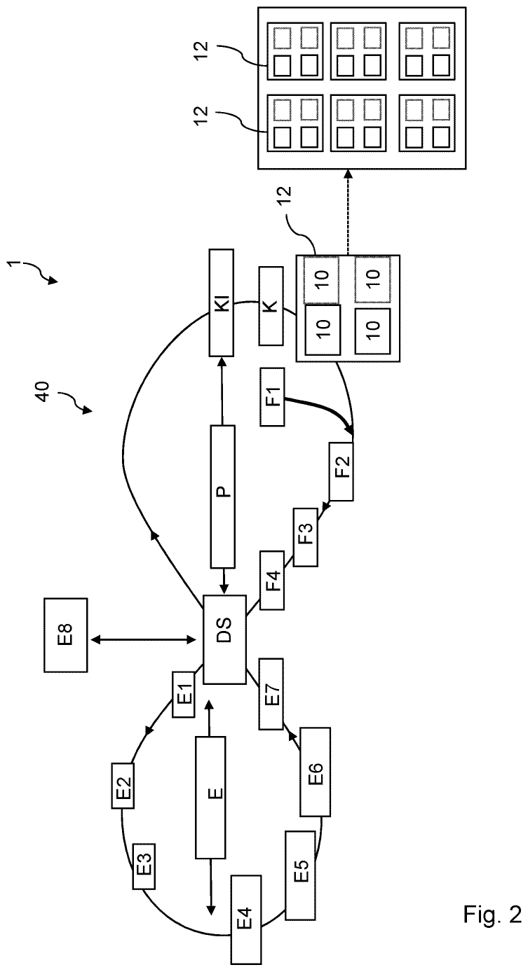

FIG. 2 shows a further diagram illustrating an exemplary manufacturing system 1 and method. Development data E is collected and used via a data interface DS to generate process target data P by way of an artificial intelligence KI. Development data E includes, for example, data E1 from product and material databases, data E2 based on empirical data originating from production, quality data E3, data E4 based on an installation space model, requirements E5 from databases, data E6 based on design requirements and/or structural data E7.

Based on the process target data P, components are produced in additive production processes by way of production devices 10. Several production devices 10 are arranged, for example, in a common manufacturing cell 12. Preferably, the production devices are networked with one another, so that communication between individual manufacturing components forms part of the manufacturing system 1.

During and after the production of the (vehicle) components, field data F is acquired and forwarded to the data interface DS. Acquired as field data F are, for example, process data F1, data F2 based on post-processing in processes such as micro-processing or macro-processing, data F3 based on post-processing after the actual production process and/or quality data F4 of the components. These field data are fed back into the manufacturing system, for example via the data interface DS. The artificial intelligence KI then creates optimized process target data and/or optimized development data based on the field data, which in turn serve as the basis for the production of new components.

Such a manufacturing system 1 can be arbitrarily scaled to manufacturing systems (illustrated by a dashed arrow) with more production devices 10 or more manufacturing cells 12, thereby ensuring a flexible adaptation to modified production requirements.

List of reference signs

| | |
|---|---|
| 1 | Manufacturing system |
| 10 | Production devices |
| 12 | Manufacturing cell |
| 20 | Data acquisition device |
| 30 | Data processing device |
| 40 | Data platform |
| 50 | Post-processing processes |
| E, E′, E1-E7 | Development data |
| F, F1-F4 | Field data |
| DS | Data interface |
| KI | Artificial intelligence |
| P, P′ | Process target data |

1.-14. (canceled)

15. A manufacturing system for producing components comprising:
production devices for performing additive manufacturing processes for producing the components using process target data,
at least one data acquisition device for acquiring field data which characterizes the produced components and/or the manufacturing processes performed,
at least one data processing device for evaluating the field data and generating optimized development data and/or for generating optimized process target data using the field data,
wherein the manufacturing system is designed to be self-regulating, whereby the optimized process target data are used by the production devices for producing further components.

16. The manufacturing system according to claim 15, further comprising:
a digital data platform, on which at least the optimized development data, the optimized process target data and the field data are stored.

17. The manufacturing system according to claim 16, wherein the data platform is designed to be cloud-based.

18. The manufacturing system according to claim 16, in which construction data, data from product and material databases, quality data, design-specific data, installation space data and/or requirement data are stored on the digital data platform as development data.

19. The manufacturing system according to claim 16, in which
quality data of the produced components and manufacturing process data of the manufacturing processes and/or post-processing processes performed are acquired as field data.

20. The manufacturing system according to claim 15, in which
self-learning artificial intelligence is used for generating the optimized development data and/or the optimized process data.

21. The manufacturing system according to claim 15, in which
a plurality of production devices are arranged in a common manufacturing cell.

22. The manufacturing system according to claim 15, in which
the production devices are configured to perform a wire-based additive manufacturing process.

23. The manufacturing system according to claim 15, which is configured for producing vehicle components.

24. A method for producing components, in which
components are produced in additive manufacturing processes by way of production devices in a manufacturing system using process target data, wherein
field data characterizing the produced components and/or the manufacturing processes performed are acquired,
the field data are evaluated by at least one data processing device and optimized development data and/or optimized process target data are generated using the field data,
and the optimized process target data are used to produce further components by way of the production devices.

25. The method according to claim 24, in which
the generation of optimized development data and/or optimized process target data takes place within a production cycle.

26. The method according to claim 24, in which
the additive manufacturing processes include a wire-based additive manufacturing process.

27. The method according to any of claim 24,
in which vehicle components are produced as components.

28. The method according to claim 24, which is carried out with a manufacturing system according to claim 15.
